(19) United States
(12) Patent Application Publication
(10) Pub. No.: US 2026/0298432 A1
(43) Pub. Date: Oct. 1, 2026

(54) CAR LIGHT

(71) Applicant: SUPERLEE CORPORATION, TAINAN CITY (TW)

(72) Inventors: TSUNG-KENG LEE, TAINAN CITY (TW); MENG-HUANG LIN, TAINAN CITY (TW)

(21) Appl. No.: 19/090,608

(22) Filed: Mar. 26, 2025

(51) Int. Cl. F21S 41/20; F21S 41/143; F21S 41/151

(52) U.S. Cl. CPC F21S 41/285; F21S 41/143; F21S 41/151

(57) ABSTRACT

A car light is provided. In the car light, an optical coating is disposed on a light incident surface of a light pattern generating unit, a light emitting surface of a light pattern generating unit, or a light incident surface of a transparent light shade. The optical coating is in an at least four-layered structure formed by silicon dioxide (SiO₂) layers and ceramic oxide layers stacked alternately. The silicon dioxide layer is a layer in contact with the light pattern generating unit or the transparent light shade. Thereby a reflectivity of light having a specific wavelength emitted from a light source can be increased or reduced by the optical coating and color temperature of the light lastly projected from the car light is further changed for compliance with regulatory standards related to the car light.

### BACKGROUND OF THE INVENTION

### Field of the Invention

The present invention relates to a car light which uses an optical coating to reflect a light with specific wavelengths emitted from a light source of the car light and further increase or decrease a reflectivity of the light with specific wavelengths for changing color temperature of the light lastly emitted from the car light.

### Description of Related Art

Car lights are key components for safe driving. Thus car lights with different uses such as head lights, turn lights, stop lights, reversing light, high mounted stop lights, and fog lamps have certain specifications including light patterns and color temperature for compliance with regulatory standards.

Take the head light as an example. When the color temperature of the light is 4,200 K (Kelvin temperature), the color is similar to natural sunlight. Once the color temperature is up to 8,000 K or 12,000 K, the color is sky white (almost blue) or blue sky. During the range of visible light detectable by human eyes, the blue light has the shortest wavelength so that the blue light is scattered easily and having poor transmittance. Thus poor illuminance is caused in bad weather conditions. This poses great challenges to road users and increases risk of traffic accidents.

Moreover, the color temperature required for the respective car lights is obtained by light emitted from the light source being passed through a light shade. The color temperature of the light passed through the light shade may have changed due to errors in wavelengths of the light emitted from the light sources used. Thereby the color temperature of the light lastly projected from the car light is not compliant with related regulatory standards.

Thus there is room for improvement and there is a need to provide a car light which uses an optical coating to increase or decrease a reflectivity of specific wavelengths of light emitted from a light source for making wavelength or color temperature of the light emitted from the light source become compliant with regulatory requirements.

### SUMMARY OF THE INVENTION

Therefore, it is a primary object of the present invention to provide a car light using an optical coating to increase a reflectivity of light emitted from a light source of the car light and having a wavelength range not compliant with regulatory requirements, or decrease a reflectivity of light emitted from the light source of the car light and having a wavelength range compliant with regulatory requirements. Thereby the wavelength or color temperature of light lastly emitted from the light source of the car light is compliant with regulatory requirements.

In order to achieve the above objects, a car light according to the present invention includes a base, at least one light source, a light shade, and an optical coating.

The base is connected with respect to the light shade and the light source is arranged at the base. The light shade is just located at a light path along which light from the light source is projected. A surface of the light shade toward the light source is a light incident surface while a surface of the light shade away from the light source is a light emitting surface. The light shade is an optical component which converts light patterns. The optical coating is arranged at the light incident surface of the light shade. The optical coating is in an at least four-layered structure formed by silicon dioxide (SiO₂) layers and ceramic oxide layers stacked alternately. The one of the silicon dioxide layers is just adjacent to the light incident surface of the light shade. A reflectivity of the light with specific wavelengths emitted from the light source can be increased or decreased by passing through the layered structure of the optical coating.

Preferably, the light source is disposed on a substrate which is fixed on the base.

Preferably, the car light further includes a light pattern generating unit. The optical coating is mounted to a light incident surface or a light emitting surface of the light pattern generating unit.

The present car light has the following advantages.

The optical coating can be arranged at the light incident surface of the light pattern generating unit of the car light, the light emitting surface of the light pattern generating unit of the car light, or the light incident surface of the transparent light shade of the car light. The reflectivity of the light with specific wavelengths emitted from the light source can be increased or decreased after the light being passed through the optical coating. Thus the color temperature (or the wavelength) of the light lastly projected from the car light can be changed to be compliant with regulatory requirements.

### BRIEF DESCRIPTION OF THE DRAWINGS

FIG. 1 is an exploded view of an embodiment of a car light according to the present invention;

FIG. 2 is a partial sectional view of an embodiment of a car light showing layers of an optical coating according to the present invention;

FIG. 3 is an exploded view of a second embodiment of a car light according to the present invention;

FIG. 4 is a top view of a section of a second embodiment of a car light according to the present invention;

FIG. 5 is a top view of a section of a third embodiment of a car light according to the present invention;

FIG. 6 is a top view of a section of a further embodiment of a car light according to the present invention;

FIG. 7 is a full-band transmittance curve measured of light projected through an optical coating of a car light of an embodiment according to the present invention;

FIG. 8 shows measurement results of color temperature of light projected from a car light with an optical coating in a CIE (x, y) chromaticity diagram of an embodiment according to the present invention; and

FIG. 9 shows measurement results of color temperature of light projected from a car light without an optical coating in a CIE (x, y) chromaticity diagram of an embodiment according to the present invention.

### DETAILED DESCRIPTION OF THE PREFERRED EMBODIMENT

In a car light of the present invention, an optical coating is disposed on a light path along which light from the light source is projected. A reflectivity of the light with specific wavelengths from the light source can be increased or decreased by the optical coating. Thus color temperature (or the wavelength) of the light lastly projected from the car light is changed.

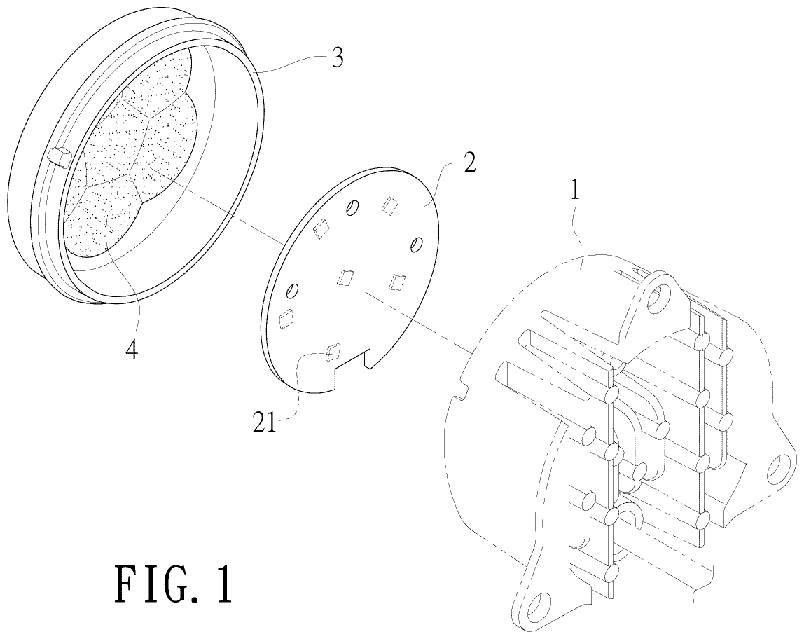

Refer to FIG. 1, a preferred embodiment of a car light according to the present invention is provided.

The car light includes a base 1, at least one light source 2, a light shade 3, and an optical coating 4.

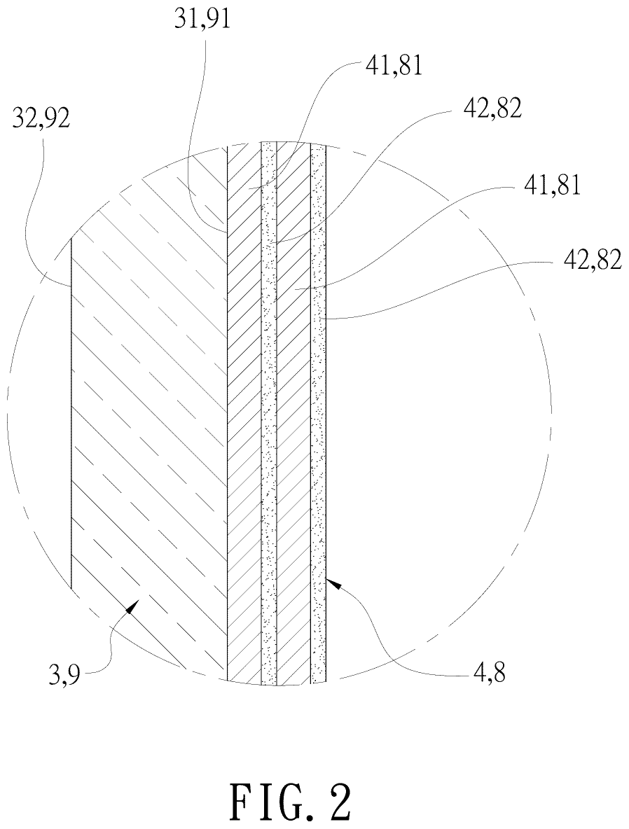

The base 1 is located at a rear end of the whole car light. The base 1 is a case with a recess and having a front side arranged and assembled with respect t to the light shade 3. By the assembly of the base 1 with the light shade 3, the recess forms a closed space. The light source 2 is arranged at the base 1 and the light shade 3 is just located at a light path along which light from the light source 2 is projected. Also refer to FIG. 2, a surface on one side of the light shade 3 toward the light source 2 is a light incident surface 31 while a surface on one side of the light shade 3 away from the light source 2 is a light emitting surface 32. The light shade 3 is an optical component which converts light patterns of the light emitted from the light source 2. The optical coating 4 is disposed on the light incident surface 31 of the light shade 3 and provided with a plurality of silicon dioxide layers 41 and a plurality of ceramic oxide layers 42 stacked alternately to form an at least four-layered structure. The silicon dioxide layer 41 is used as a layer in contact with the light incident surface 31 of the light shade 3. That means the silicon dioxide layer 41, the ceramic oxide layer 42, the silicon dioxide layer 41, and the ceramic oxide layer 42 are stacked over the incident surface 31 of the light shade 3 in turn to make the total number of the layers become at least four. The number of the staked layers and a thickness of both the silicon dioxide layer 41 and the ceramic oxide layer 42 will affect a reflectivity of the light with specific wavelength emitted from the light source 2 and passed the optical coating 4. During formation of the optical coating 4, the reflectivity of the light with specific wavelengths emitted from the light source 2 and passed the layered structure of the optical coating 4 can be increased or decreased by the number of the stacked layers and the thickness of both of the silicon dioxide layer 41 and the ceramic oxide layer 42. Thereby color temperature of the light projected from the car light can be changed.

In this embodiment, the light source 2 is disposed on a substrate 21 which is mounted to the recess of the base 1 correspondingly (as shown in FIG. 1).

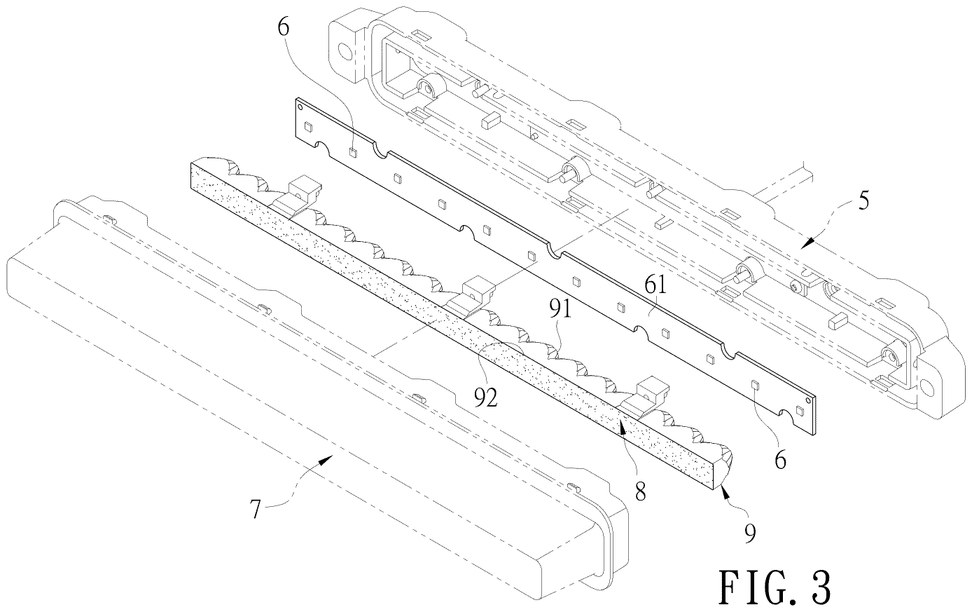

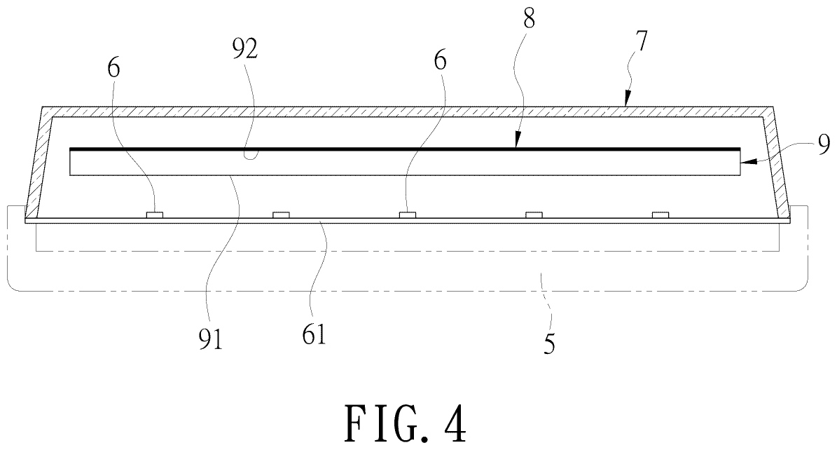

Refer to FIG. 3 and FIG. 4, a second embodiment of a car light according to the present invention is provided.

In this embodiment, the light shade 3 is a transparent shade only used for sealing the recess and protecting the light source 2.

In this embodiment, a car light of the present invention includes a base 5, at least one light source 6, a light shade 7, an optical coating 8, and a light pattern generating unit 9. The base 5 is located at a rear end of the whole car light. The base 5 is a case with a recess and has a front side assembled and connected to the light shade 7. By the assembly of the base 5 with the light shade 7, the recess forms a closed space. The light source 6 is disposed on the base 5 and the light shade 7 is just located at a light path along which light from the light source 6 is projected.

The light pattern generating unit 9 is arranged between the light source 6 and the light shade 7. Both the light shade 7 and the light pattern generating unit 9 are located on the light path of the light source 6. A surface of the light pattern generating unit 9 toward the light source 6 is a light incident surface 91 while a surface of the light pattern generating unit 9 away from the light source 6 is a light emitting surface 92. The optical coating 8 is mounted to the light emitting surface 92 of the light pattern generating unit 9 and composed of a plurality of silicon dioxide layers 81 and a plurality of ceramic oxide layers 82 stacked alternately to form an at least four-layered structure. The silicon dioxide layer 81 is used as a layer in contact with the light emitting surface 92 of the light pattern generating unit 9. That means the silicon dioxide layer 81, the ceramic oxide layer 82, the silicon dioxide layer 81, and the ceramic oxide layer 82 are stacked over the light emitting surface 92 of the light pattern generating unit 9 in turn to make the total number of the layers become at least four.

According to the above structure, a reflectivity of light with a specific wavelength emitted from the light source 6 and passed the optical coating 8 can also be changed by the number of the stacked layers and a thickness of both the silicon dioxide layer 81 and the ceramic oxide layer 82. During formation of the optical coating 8, the reflectivity of the light with specific wavelength emitted from the light source 6 and passed the layered structure of the optical coating 8 can be increased or reduced by the number of the stacked layers of the silicon dioxide layer 81 and the ceramic oxide layer 82 and the thickness of the silicon dioxide layer 81 and the ceramic oxide layer 82. Thereby color temperature of the light projected from the car light is further changed.

In the second embodiment, the light source 6 is disposed on a substrate 61 which is mounted to the recess of the base 5 correspondingly.

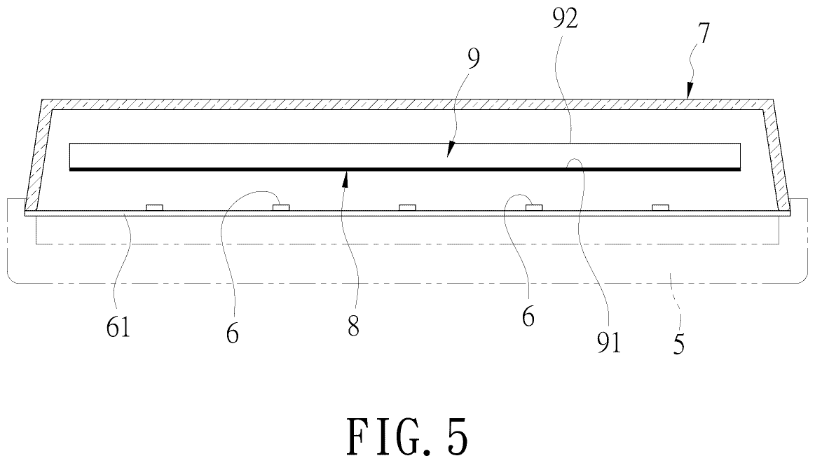

Refer to FIG. 5, a third embodiment of a car light according to the present invention is provided.

The difference between this embodiment and the second embodiment is in that the optical coating 8 is mounted to the light incident surface 91 of the light pattern generating unit 9. After the light from the light source 6 being passed the light pattern generating unit 9, the reflectivity of the light with specific wavelength emitted from the light source 6 and passed the layered structure of the optical coating 8 can be increased or reduced by the number of the stacked layers and the thickness of the silicon dioxide layer 81 and the ceramic oxide layer 82. Thereby color temperature of the light projected from the car light is further changed.

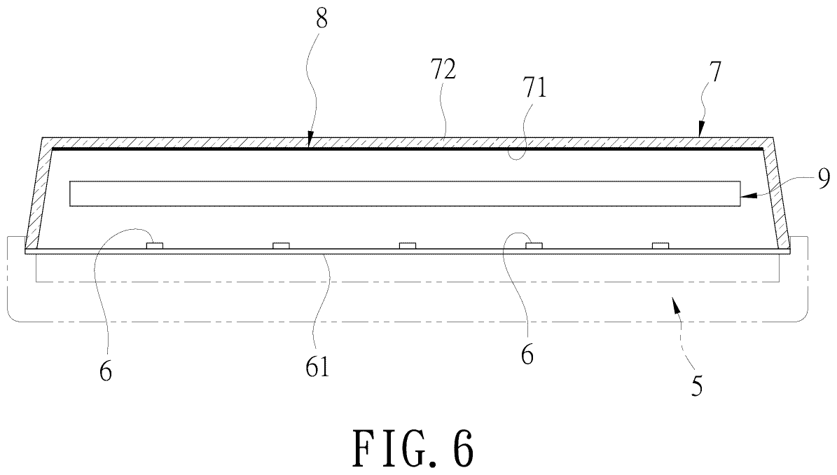

As shown in FIG. 6, a fourth embodiment of a car light according to the present invention is provided. The difference between this embodiment and the second and the third embodiments mentioned above is in that the optical coating 8 is formed on a light incident surface 71 of the light shade 7. A reflectivity of light having specific wavelength and emitted from the light source 6 can be increased or reduced by the design of the optical coating 8. Thereby color temperature of the light projected from the car light is further changed.

In the above car light, the light source 6 is disposed on a substrate 10 which is secured on the base 5.

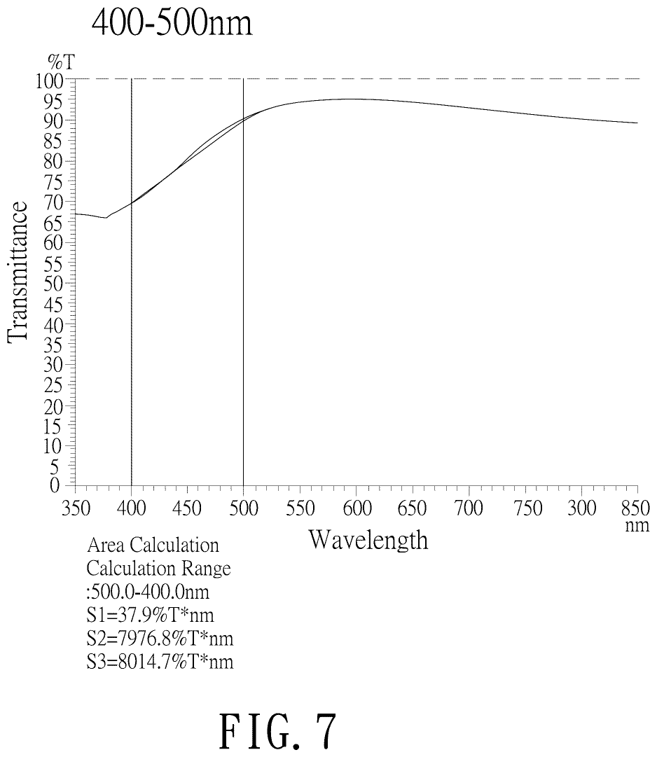

Refer to FIG. 7, a full-band transmittance curve measured of the light projected from a light source through an optical coating of a car light is provided. The thickness of both the silicon dioxide layer and the ceramic oxide layer of the optical coating have been designed. The transmittance of the light in the range of wavelength 400-500 nm is 80%. That means the reflectivity of the optical coating in the 400-500 nm wave band is 20%.

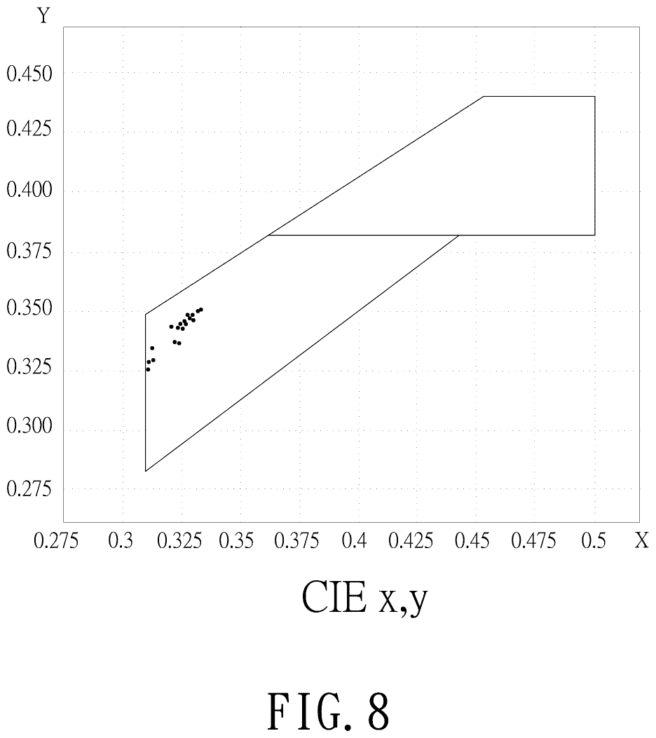

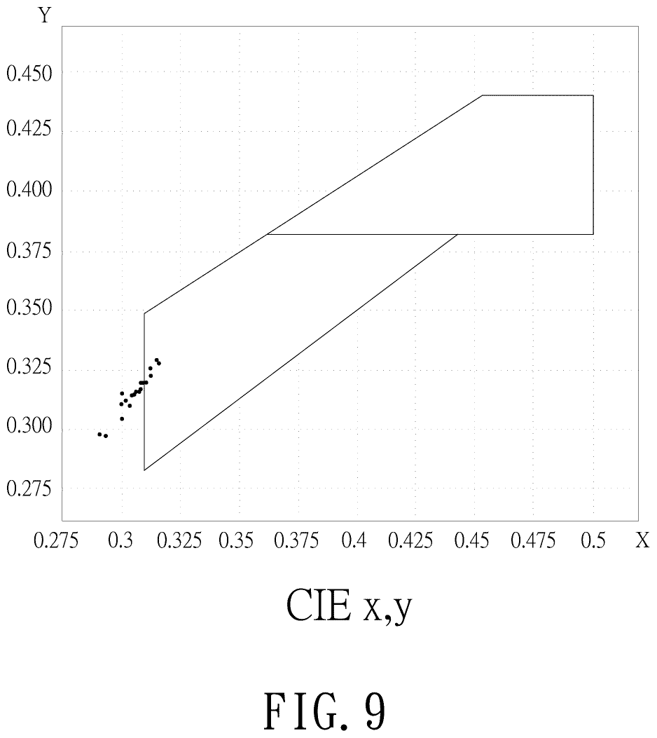

FIG. 8 shows measurement results of color temperature of light projected from a car light with an optical coating in a CIE (x, y) chromaticity diagram of an embodiment according to the present invention. The optical coating is four-layered formed by the silicon dioxide layers and the ceramic oxide layers stacked alternately and arranged at the light shade and the light pattern generating unit. FIG. 9 shows measurement results of color temperature of light projected from a car light without an optical coating in a CIE (x, y) chromaticity diagram of an embodiment according to the present invention. Comparing FIG. 8 with FIG. 9, it is evident that the color temperatures of the light projected from the car light with the optical coating as a whole are shifted to the upper right.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A car light, comprising: a base, at least one light source, a light shade, and an optical coating having a predefined reflectivity; wherein the base and the light shade are connected to each other, and wherein the at least one light source is arranged at the base; the light shade being located along a light path of the at least one light source; wherein a surface of the light shade facing towards the at least one light source is a light incident surface and a surface of the light shade facing away from the at least one light source is a light emitting surface; the light shade being a light transmissive housing; the optical coating being disposed on the light incident surface of the light shade; wherein the optical coating is at least a four-layered structure formed by a plurality of alternately stacked silicon dioxide and ceramic oxide layers; wherein one of the plurality of silicon dioxide layers is directly disposed on the light incident surface of the light shade; and a reflection of light having specific wavelengths and emitted from the at least one light source is either of increased or decreased subsequent to the light emitted from the at least one light source interacting with the optical coating.

2. The car light as claimed in claim 1, wherein the at least one light source is disposed on a substrate which is fixed to the base.

3. A car light, comprising: a base, at least one light source, a light shade, an optical coating having a predefined reflectivity, and a light pattern generating unit; wherein the base and the light shade are connected to each other, and wherein the at least one light source is disposed on the base; the light pattern generating unit being a light transmissive optical diffuser and being arranged between the at least one light source and the light shade; the light shade being a light transmissive housing, and both the light shade and the light pattern generating unit being located along a light path of the at least one light source; wherein a surface of the light pattern generating unit facing towards the at least one light source is a light incident surface and a surface of the light pattern generating unit facing away from the at least one light source is a light emitting surface; the optical coating being disposed on the light incident surface of the light pattern generating unit; wherein the optical coating is at least a four-layered structure formed by a plurality of alternately stacked silicon dioxide and ceramic oxide layers; wherein one of the plurality of silicon dioxide layers is directly disposed on the light incident surface of the light pattern generating unit; and a reflection of light having specific wavelengths and emitted from the at least one light source is either of increased or decreased subsequent to the light emitted from the at least one light source interacting with the optical coating.

4. The car light as claimed in claim 3, wherein the at least one light source is disposed on a substrate which is fixed to the base.

5. A car light, comprising: a base, at least one light source, a light shade, an optical coating having a predefined reflectivity, and a light pattern generating unit; wherein the base and the light shade are connected to each other and wherein the at least one light source is disposed on the base; the light pattern generating unit being a light transmissive optical diffuser and being mounted between the at least one light source and the light shade; the light shade being a light transmissive housing and both the light shade and the light pattern generating unit being located along a light path of the at least one light source; wherein a surface of the light pattern generating unit facing towards the at least one light source is a light incident surface and a surface of the light pattern generating unit facing away from the at least one light source is a light emitting surface; the optical coating being disposed on the light emitting surface of the light pattern generating unit; wherein the optical coating is an at least a four-layered structure formed by a plurality of alternately stacked silicon dioxide and of ceramic oxide layers; wherein one of the plurality of silicon dioxide layers is directly disposed on the light emitting surface of the light pattern generating unit; and a reflection of light having specific wavelengths and emitted from the at least one light source is either of increased or decreased subsequent to the light emitted from the at least one light source interacting with the optical coating.

6. The car light as claimed in claim 5, wherein the at least one light source is disposed on a substrate which is fixed to the base.

7. A car light, comprising: a base, at least one light source, a light shade, an optical coating having a predefined reflectivity, and a light pattern generating unit; wherein the base and the light shade are connected to each other, and wherein the at least one light source is disposed on the base; the light pattern generating unit being a light transmissive optical diffuser and being arranged between the at least one light source and the light shade; the light shade being a light transmissive housing and both the light shade and the light pattern generating unit being located along a light path of the at least one light source; wherein the light shade covers both the light pattern generating unit and the at least one light source; wherein a surface of the light pattern generating unit facing towards the at least one light source is a light incident surface of the light pattern generating unit and a surface of the light pattern generating unit facing away from the at least one light source is a light emitting surface of the light pattern generating unit, thereby light emitted from the at least one light source enters the light pattern generating unit through the light incident surface thereof and exits the light pattern generating unit through the light emitting surface thereof, wherein the light pattern generating unit diffuses the light emitted from the light source for performing light pattern conversion thereon; wherein a surface of the light shade facing towards the at least one light source is a light incident surface of the light shade and a surface of the light shade facing away from the at least one light source is a light emitting surface of the light shade; the optical coating being disposed on the light incident surface of the light shade; wherein the optical coating is at least a four-layered structure formed by a plurality of alternately stacked silicon dioxide and ceramic oxide layers; wherein one of the plurality of silicon dioxide layers is directly disposed on the light incident surface of the light shade; and a reflection of light having specific wavelengths and emitted from the at least one light source and projected via the light emitting surface of the light shade is either of increased or decreased subsequent to the light emitted from the at least one light source and subjected to the light pattern conversion by the light pattern generating unit interacting with the optical coating.

8. The car light as claimed in claim 7, wherein the at least one light source is disposed on a substrate which is fixed to the base.
